(19) United States
(12) Patent Application Publication
(10) Pub. No.: US 2020/0362908 A1
(43) Pub. Date: Nov. 19, 2020

(54) QUICK CONNECT ADJUSTMENT DEVICE

(71) Applicant: Richard Glenn Rhett, JR., Chattanooga, TN (US)

(72) Inventor: Richard Glenn Rhett, JR., Chattanooga, TN (US)

(21) Appl. No.: 15/929,619

(22) Filed: May 13, 2020

Related U.S. Application Data
(60) Provisional application No. 62/847,526, filed on May 14, 2019.

(51) Int. Cl. F16B 45/02

(52) U.S. Cl. CPC F16B 45/02

(57) ABSTRACT

The present invention provides an adjustable quick connect device and a cinch buckle device with quick connect. The devices have a body or frame with a first end and a second end. The first end has a hook defining an opening. The second end has a slider aperture. The devices include a slider operatively associated with the slider aperture.

### CROSS-REFERENCE TO RELATED APPLICATION

This application claims the benefit of priority of U.S. provisional application No. 62/847,526, filed May 14, 2019, the contents of which are herein incorporated by reference.

### BACKGROUND OF THE INVENTION

The present invention relates to a quick connect device and, more particularly, to an adjustable quick connect device.

Users desire a single device for use on their camping hammock or when securing one object to another object. Adjustment, primarily loosening and tightening, is also desirable to change the position of the connected article in reference to a fixed location.

Currently, the ability to quickly attach any camping hammock and then adjust it with a single device does not exist. Existing devices do not allow users to attach to a device quickly and securely with a closed gate and then adjust the attachment to obtain a desired distance between the connected articles. Currently what is available is either a carabiner which only provides connections or a cinch buckle which only provides adjustment. Neither of these options combine secure attachment and locking adjustability. Moreover, neither article combines a slider for adjustment and a wire gate for secure connection. Cam locking devices are too heavy and cumbersome to be used in this outdoor recreational application and do not provide a quick attachment.

As can be seen, there is a need for a quick connect device that also provides length adjustment.

The present invention provides a quick connect device that allows for the quick connection and adjustability. The inventive device comprises a first end having a hook with a spring biased entrance and a second end having a cinch buckle system. The device allows a user to attach a hammock or camping item quickly and securely to the device and to quickly adjust the position of the attached hammock or camping item in relation to a fixed anchor point. For example, the device allows hammock campers to quickly attach a hammock to a hammock suspension and to adjust the hammock using a cinch buckle slider, all in a single device. The device is light weight, generally under about 2 ounces, requires no knots, and its use is very intuitive for the user.

By combining two functions, we have created a more enjoyable experience that gives the user a secure, fast connection with the ability to change the position of the connected article by tightening or loosening the inventive device. The inventive adjustable quick connect device may be used with a fixed attached point or with a mobile attached point. The present invention may also be used to tie down a load on a trailer, rather than using the traditional cam locking devices, as well as to secure a strap to a backpack when adjustability and strength is needed.

### SUMMARY OF THE INVENTION

In one aspect of the present invention, an adjustable quick connect device comprises a body having a first end comprising a hook defining an opening and a second end having a slider aperture; and a slider operatively associated with the slider aperture.

In another aspect of the present invention, cinch buckle device with quick connect, comprises a frame having a first end and a second end, said first end having a hook defining an opening into the first end and said second end having a slider aperture; and a slider slidable within the slider aperture.

These and other features, aspects and advantages of the present invention will become better understood with reference to the following drawings, description and claims.

### BRIEF DESCRIPTION OF THE DRAWINGS

FIG. 1 is a front perspective view of a device according to an embodiment of the invention;

FIG. 2 is another front perspective view thereof illustrating component movement;

FIG. 3 is a front elevation view thereof;

FIG. 4 is a side elevation view thereof;

FIG. 5 is a detail perspective view of the slider of FIG. 1;

FIG. 6 is a perspective view of the device of FIG. 1 in use;

FIG. 7 is a side elevation view taken along line 8-8 of FIG. 6 with parts broken away, showing the device thereof in a relaxed mode; and

FIG. 8 is a side elevation view taken along line 8-8 of FIG. 6, showing the device thereof under load.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, “slot” refers to an opening within a frame or body that is bordered on the top, bottom, left, and right by the frame or body.

“Quick connect”, as used herein, refers to a hook or gated opening that may secure a webbing or strap.

Broadly, one embodiment of the present invention is an adjustable quick-connect device comprising a frame with a hook and a slider. In some embodiments, the device further comprises a wire gate.

The frame acts as the foundation for the device and provides an opening for the slider and an opening for the wire gate. The slider, installed into the frame, may provide a friction hold on the webbing inserted into the frame. When a load is applied, the slider may seize the webbing and lock it into place. The wire gate may be spring loaded and may bridge the gap created by the hook. The gate generally serves as only an entry point until the gate is manually depressed to provide an exit gap.

In some cases, a loop of webbing may be added in the slot on the frame distal to the hook to provide more leverage in the adjustment of the device, primarily when the user is loosening the device.

The frame and hook may be manufactured from a mold, machined, or welded in a multitude of ways. The slider may be extruded, machined, or manufactured with a mold. The gate may be a formed wire. The frame, hook, slider, and gate may be manufactured from a material that maintains its structural integrity under loading, such as a rigid plastic or a metal, preferably a metal. The type of webbing used, and its manufacture, are not particularly limited. In some cases, the webbing may be about ½″ to about 2″ wide, such as about 1″ wide, and may be generally about 10-25′ long, such as about 15-20′ long.

The inventive device may be used with a load such as a hammock. The present invention may also be used to lash an article to make it secure. For example, the present invention may be used to tie down a load on a trailer, replacing traditional cam locking devices.

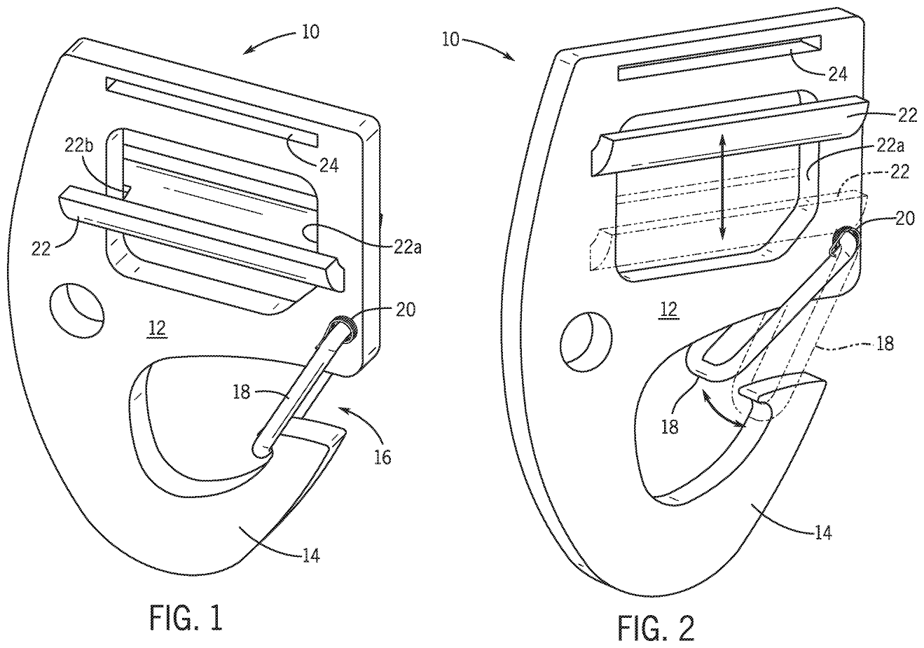

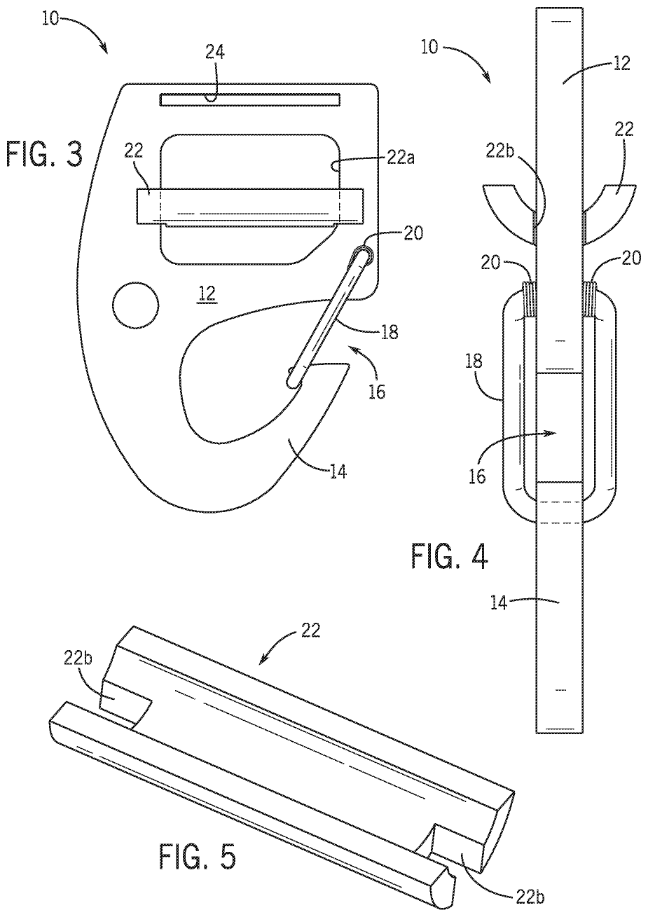

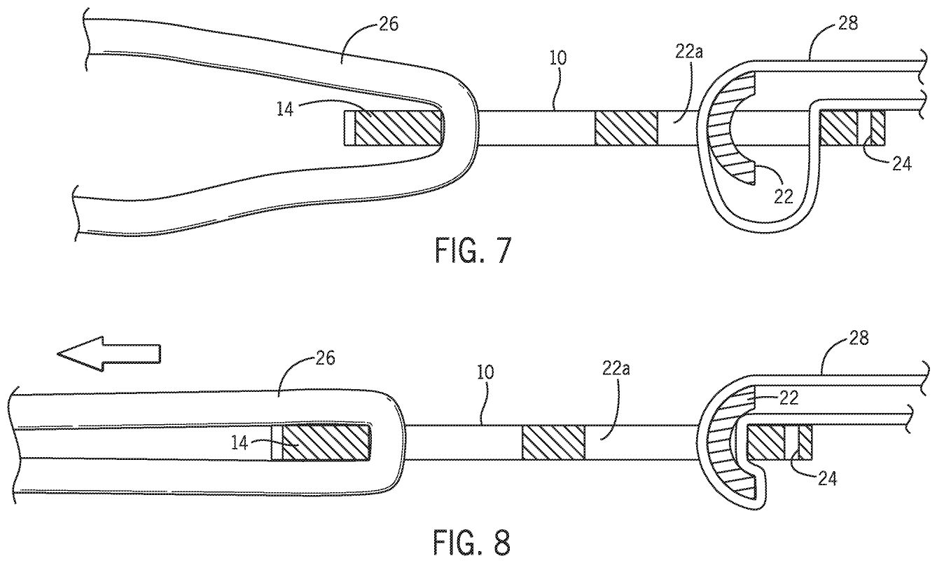

Referring to FIGS. 1-8, FIGS. 1, 3, and 4 illustrate an adjustable quick connect device 10 according to an embodiment of the invention. The device 10 may comprise a body or frame 12 for structural support having a first end opposite a second end. The first end of the body 12 may have a hook 14 forming an entranceway 16 into the body 12. The entranceway 16 may be bridged with a wire gate 18. Torsion springs 20 may bias the gate 18 against the hook 14 in a closed position. The second end of the body 12 may include a slider opening or slider aperture 22a fitted with a slider 22 having a slot 22b at each end (see FIG. 5) to form a cinch buckle. The body 12 may further have a slot 24 through which a loop of webbing (not shown) may be provided to give additional leverage. As shown in FIG. 2, the spring biased gate 18 may rotate inwards in an open position into a gap formed by the hook within the frame and the slider 22 may freely slide up and down inside the slider opening 22a.

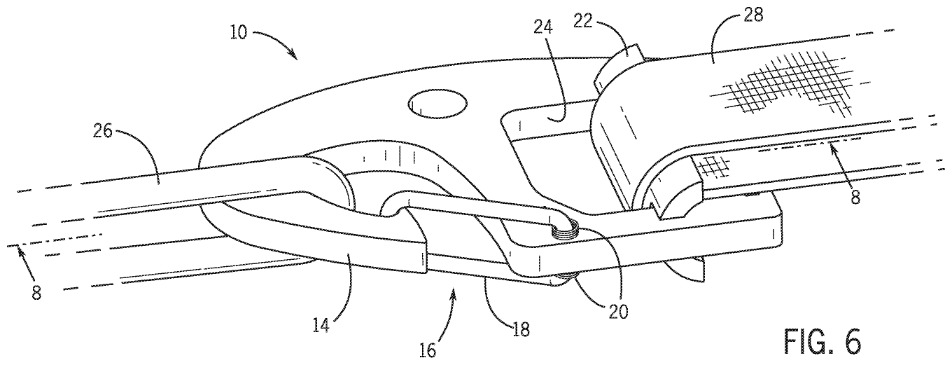

FIGS. 6-8 illustrate use of the inventive device. Webbing 28 may be inserted into the frame 12 and around the slider 22. One end of the webbing may exit the body to form a tail 8. A hammock or other attachment 26 may be attached to the hook 14 and secured by the wire gate 18. The tail 8 of the webbing 28 may be pulled or pushed to adjust the position of the frame 12, thereby adjusting the position of the attachment 26.

It should be understood, of course, that the foregoing relates to exemplary embodiments of the invention and that modifications may be made without departing from the spirit and scope of the invention as set forth in the following claims.

What is claimed is:

1. An adjustable quick connect device, comprising:
a. a body having:
i. a first end comprising a hook defining an opening and
ii. a second end having a slider aperture; and
b. a slider operatively associated with the slider aperture in such a way that the slider slides within the slider aperture.

2. The adjustable quick connect device of claim 1, wherein the first end further comprises a gate across the opening, said gate comprising at least one torsion spring operable to bias the gate against the hook and to securely close the opening.

3. The adjustable quick connect device of claim 1, wherein the second end further comprises a webbing threaded through the slider aperture around the slider.

4. The adjustable quick connect device of claim 1, wherein said second end further comprises a leverage slot.

5. A cinch buckle device with quick connect, comprising:
a. a frame having a first end and a second end, said first end having a hook defining an opening into the first end and said second end having a slider aperture; and
b. a slider operatively associated with the slider aperture.

6. The cinch buckle device of claim 5, wherein the first end further comprises a gate spring-biased against the hook.

7. The cinch buckle device of claim 5, wherein the second end further comprises a webbing threaded through the slider aperture around the slider.

8. The cinch buckle device of claim 5, wherein said second end further comprises a leverage slot.

9. The cinch buckle device of claim 8, further comprising webbing looped through said leverage slot.

10. The cinch buckle device of claim 5, wherein the slider is slidable within the slider aperture.
